(19) United States
(12) Patent Application Publication
(10) Pub. No.: US 2024/0301976 A1
(43) Pub. Date: Sep. 12, 2024

(54) PIPE END FITTING WITH IMPROVED VENTING

(71) Applicant: Trinity Bay Equipment Holdings, LLC, Houston, TX (US)

(72) Inventors: Matthew Allen Hegler, Kingwood, TX (US); Andrew James Heaton, Lincolnshire (GB)

(21) Appl. No.: 18/666,969

(22) Filed: May 17, 2024

Related U.S. Application Data
(63) Continuation of application No. 17/341,059, filed on Jun. 7, 2021, now Pat. No. 12,000,512.
Application No. 17/341,059 is a continuation of application No. 16/249,609, filed on Jan. 16, 2019, now Pat. No. 11,028,951.
Application No. 16/249,609 is a continuation of application No. 13/644,891, filed on Oct. 4, 2012, now Pat. No. 10,184,603.
(60) Provisional application No. 61/543,247, filed on Oct. 4, 2011.

(51) Int. Cl. F16L 35/00; F16L 9/19; F16L 13/02; F16L 33/207; F16L 39/00

(52) U.S. Cl. CPC F16L 35/00; F16L 9/19; F16L 13/02; F16L 33/2071; F16L 39/005; Y10T 29/49879; Y10T 29/49968

(57) ABSTRACT

A pipe end fitting assembly that includes an outer body having an outer surface, an inner surface defining first bore, and an end surface, and an inner body having an inner surface defining a second bore and an outer surface. A portion of the inner body outer surface is secured to the outer body inner surface. A passage formed in the outer body includes a first portion extending from the end surface and parallel to the first bore, and a second portion extending from the outer body outer surface to the passage first portion. A pipe end is disposed around and secured to a portion of the inner body outer surface. A jacket is disposed around the pipe and has an end secured to the outer body outer surface. The passage portions are fluid communication with each other and a space between the jacket and the pipe.

### CROSS-REFERENCE

The present disclosure is a continuation of U.S. Non-Provisional application Ser. No. 17/341,059, entitled “PIPE END FITTING WITH IMPROVED VENTING” and filed Jun. 7, 2021, which is a continuation of U.S. Non-Provisional application Ser. No. 16/249,609, entitled “PIPE END FITTING WITH IMPROVED VENTING,” filed Jan. 16, 2019, and now U.S. Pat. No. 11,028,951, which is a continuation of U.S. Non-Provisional application Ser. No. 13/644,891, entitled “PIPE END FITTING WITH IMPROVED VENTING,” filed Oct. 4, 2012, and now U.S. Pat. No. 10,184,603, which claims priority to and benefit of U.S. Provisional Application No. 61/543,247, entitled “PIPE END FITTING WITH IMPROVED VENTING” and filed Oct. 4, 2011, which are each incorporated herein by reference its entirety for all purposes.

### FIELD OF THE INVENTION

The present invention relates to pipe end fittings, and more particularly to a pipe end fitting for use with pipes having an external jacket for capturing any leaked liquid or gas.

### BACKGROUND OF THE INVENTION

FIG. 1 is a cross sectional view illustrating a conventional pipe end fitting 1. The end fitting 1 is machined from a single piece of stock, such as carbon or stainless steel. The end fitting includes a center bore 2, a securing end 4 and a pipe attachment end 6. An annular connector notch 12 is formed on the outer surface near the securing end 4 for securing the end fitting 1 to its destination (e.g. a well head valve). The fitting 1 also includes a serrated pipe connector 14 at the pipe attachment end 6 for receiving and securing the end of an inner pipe 16 of a pipe assembly 18. The pipe assembly 18 additionally includes a jacket 20 surrounding the inner pipe 16. Jacket 20 provides a compression fit for the connection of the pipe assembly 18 to end fitting 1, and captures any liquids or gasses that may have leaked from the inner pipe 16. A weld 22 is used to secure jacket 20 to the end fitting 1. The jacket 20 includes a vent port 24 extending therethrough near the weld 22. The vent port 24 is used to vent any leaked liquid/gasses captured by the jacket 20.

There are several disadvantages of the illustrated conventional end fitting 1. Because of the length and width of the end fitting 1, machining the end fitting 1 from a single piece of stock material is costly, time consuming, and wasteful of stock material. In addition, the vent port 24 formed in the jacket 20 can be deformed during the swage process used to mount the pipe assembly 18 to the end fitting 1, which can cause the vent port 24 to leak.

There is a need for an improved end fitting that addresses the above mentioned issues.

### BRIEF SUMMARY OF THE INVENTION

The aforementioned problems and needs are addressed by a pipe end fitting assembly that includes an outer body having an outer surface, an inner surface defining a first bore, and an end surface extending between the inner and outer surfaces. An inner body has an inner surface defining a second bore and an outer surface, wherein a first portion of the inner body outer surface is secured to the outer body inner surface. A passage is formed in the outer body extending from the end surface to the outer surface of the outer body, wherein the passage includes a first portion extending from the end surface and parallel to the first bore, and a second portion extending from the outer surface of the outer body to the first portion of the passage, wherein the first and second portions of the passage are in fluid communication with each other.

In another aspect of the invention, a pipe assembly includes an outer body having an outer surface, an inner surface defining a first bore, and an end surface extending between the inner and outer surfaces. An inner body has an inner surface defining a second bore and an outer surface, wherein a first portion of the inner body outer surface is secured to the outer body inner surface. A passage is formed in the outer body extending from the end surface to the outer surface of the outer body, wherein the passage includes a first portion extending from the end surface and parallel to the first bore, and a second portion extending from the outer surface of the outer body to the first portion of the passage. A pipe has an end disposed around and secured to a second portion of the inner body outer surface. A jacket disposed around the pipe and having an end secured to the outer body outer surface. The first and second portions of the passage are in fluid communication with each other and with a space extending between the jacket and the pipe.

In yet another aspect of the invention, a method of forming a pipe assembly includes forming an outer body having an outer surface, an inner surface defining a first bore, and an end surface extending between the inner and outer surfaces, forming a passage in the outer body extending from the end surface to the outer surface of the outer body, wherein the passage includes a first portion extending from the end surface and parallel to the first bore, and a second portion extending from the outer surface of the outer body to the first portion of the passage, forming an inner body having an inner surface defining a second bore and an outer surface, securing a first portion of the inner body outer surface to the outer body inner surface, securing an end of a pipe around and to a second portion of the inner body outer surface, and securing an end of a jacket to the outer body outer surface, wherein the jacket is disposed around the pipe. The first and second portions of the passage are in fluid communication with each other and with a space extending between the jacket and the pipe.

Other objects and features of the present invention will become apparent by a review of the specification, claims and appended figures.

### BRIEF DESCRIPTION OF DRAWINGS

FIG. 1 is a side cross sectional view of a conventional pipe end fitting.

FIG. 2 is a side cross sectional view of the pipe end fitting assembly of the present invention.

### DETAILED DESCRIPTION OF THE INVENTION

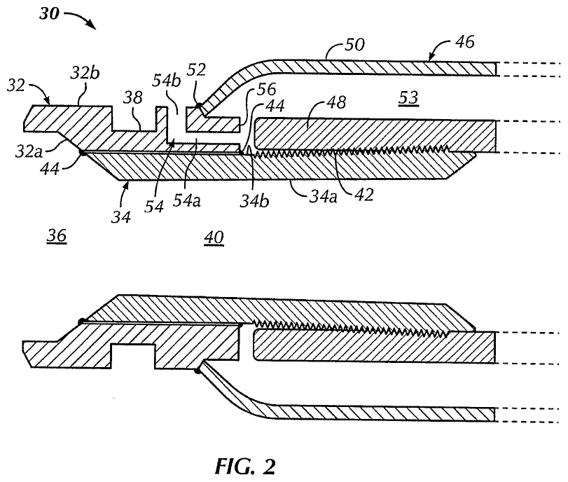

The present invention is pipe end fitting assembly 30, which is illustrated in FIG. 2. The pipe end fitting assembly 30 constitutes two separate components that are affixed to each other: the outer body 32 and the inner body 34.

The outer body 32 is generally cylindrically shaped having an inner surface 32a that defines a bore 36 extending longitudinally through the outer body. A connector notch 38 is formed on the outer surface 32b of outer body 32 (to facilitate connection to its destination). The inner body 34 is generally cylindrically shaped with an inner surface 34a that defines a bore 40 extending longitudinally through the inner body 34. One end of the inner body 34 has serrations on the outer surface 34b of the inner body 34, forming a serrated pipe connector 42 (for receiving and securing a pipe end). The other end of the inner body 34 is disposed in bore 36 and mounted to the outer body 32. Specifically, the outer surface 34b of inner body 34 is secured to the inner surface 32a of the outer body 32, preferably with a press-fit (i.e. shear force between the inner surface 32a of outer body 32 and the outer surface 34b of inner body 34, creating an interference fit therebetween). The interference fit can optionally be temperature enhanced, where one of the inner/outer bodies is heated and the other is cooled before being fitted together so additional compressive forces are generated after being fitted together as they equalize in temperature. Optional welds 44 can be formed at the edges of the inner/outer bodies 32/34, which constitute a redundant seal to contain pressurized liquids/gasses. Serrations or threads could additionally or alternatively be used to secure the outer and inner bodies 32/34 together for enhanced tensile capacity.

A pipe assembly 46 connects to the pipe end fitting 30. Pipe assembly 46 includes an inner pipe 48 and a jacket 50 surrounding the inner pipe 48. The end of the inner pipe 48 slides over and engages the serrated pipe connector 42. The end of the jacket 50 is secured to the outer body 32 by a weld 52. Any liquids or gasses that leak out of pipe 48 and into the space 53 between pipe 48 and jacket 50 are captured by jacket 50 and guided to the end fitting assembly 30.

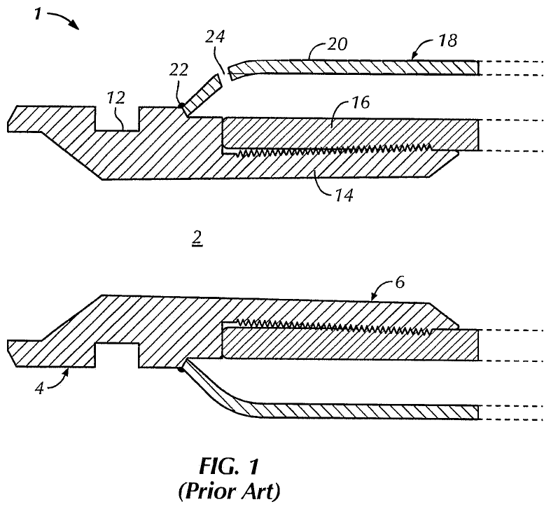

A vent passage 54 is formed through the outer body 32, providing venting for space 53. Preferably, passage 54 includes a first passage portion 54a extending longitudinally within the outer body 32 (parallel to bore 36), and a second passage portion 54b extending outwardly from the first passage portion 54a to the outer surface 32b of outer body 32 (i.e. first and second passage portions 54a/54b are orthogonal to each other). The formation of the first passage portion 54a was not feasible in the conventional design of FIG. 1 because the excessive length of the serrated pipe connector 14 blocked access to the surface in which such a passage could be made (i.e. most drilling or material removing machinery requires full access to the surface in which drilling or material removal is to be performed). However, with the design of FIG. 2, first passage portion 54a can be reliably made in outer body 32 before it is mounted to inner body 34, where end surface 56 of outer body 32 (into which first passage portion 54a is formed) is fully accessible. Likewise, second passage portion 54b is machined into the outer surface 32b of outer body 32 (which is fully accessible as well) until the two passage portions 54a/54b meet. Passage 54 provides fluid communication between space 53 and the outer surface 32b of outer body 32, where leaked liquids or gasses in space 53 can be vented and captured. The multi-portion passage 54 is far more reliable than the conventional technique of forming the vent port in the jacket itself, where unintended deformation and leaking can occur.

Another advantage of the forming end fitting assembly 30 using two separate bodies 32/24 attached together is the optimization/minimization of material stock used to make end fitting assembly 30. Smaller dimensioned stock material can be used to individually form the inner and outer bodies 32/24, which significantly lowers the amount of stock material that is wasted compared to machining the end fitting as a single piece of material. The machining processes for fabricating the inner and outer bodies 32/34 is simplified, making them faster and less expensive to make compared to the single piece end 10 fitting of FIG. 1.

It is to be understood that the present invention is not limited to the embodiment(s) described above and illustrated herein, but encompasses any and all variations falling within the scope of the appended claims. For example, references to the present invention herein are not intended to limit the scope of any claim or claim term, but instead merely make reference to one or more features that may be covered by one or more of the claims. Materials, processes and numerical examples described above are exemplary only, and should not be deemed to limit the claims. Further, as is apparent from the claims and specification, not all method steps need be performed in the exact order illustrated or claimed, but rather in any order that allows the proper formation of the pipe end fitting of the present invention.

What is claimed is:

1. A pipe fitting assembly, comprising:
a fitting body that defines a bore that extends through the pipe fitting assembly; and
a jacket secured to the fitting body such that the jacket extends circumferentially and axially around a portion of the fitting body to define a space extending between the jacket and the fitting body, wherein:
the jacket is configured to be swaged around a pipe disposed in the space between the jacket and the fitting body such that the jacket is conformally deformed around the pipe to facilitate securing and sealing tubing of the pipe in the pipe fitting assembly; and
the fitting body comprises a vent passage that opens through an axial end face of the fitting body to the space between the jacket and the fitting body and through a radial outer surface of the fitting body to facilitate venting fluid from the space between the jacket and the fitting body out of the pipe fitting assembly.

2. The pipe fitting assembly of claim 1, wherein the fitting body comprises:
an inner body that defines the bore that extends through the pipe fitting assembly; and
an outer body ring secured circumferentially around the inner body, wherein:
an axial end of the jacket is secured to the outer body ring; and
the outer body ring comprises:
the vent passage; and
a connector notch on the radial outer surface of the fitting body.

3. The pipe fitting assembly of claim 2, wherein the inner body of the fitting body comprises serrations configured to engage the tubing of the pipe to facilitate securing the tubing of the pipe in the pipe fitting assembly.

4. The pipe fitting assembly of claim 2, wherein the inner body does not extend radially beyond the outer body ring.

5. The pipe fitting assembly of claim 1, wherein the vent passage comprises:
a first portion that opens through the axial end face of the fitting body to the space between the jacket and the fitting body and extends parallel to the bore of the pipe fitting assembly; and
a second portion that connects to the first portion of the vent passage and opens through the radial outer surface of the fitting body.

6. The pipe fitting assembly of claim 5, wherein the second portion of the vent passage is perpendicular to the bore of the pipe fitting assembly.

7. The pipe fitting assembly of claim 5, wherein the first portion of the vent passage does not extend completely through the fitting body.

8. A method of implementing a pipe fitting assembly, comprising:
forming a fitting body to define a bore that extends through the pipe fitting assembly;
securing to the fitting body an axial end of a jacket, which is to be swaged around a pipe to facilitate securing and sealing tubing of the pipe in the pipe fitting assembly, such that the jacket extends circumferentially and axially around a portion of the fitting body to define a space extending between the jacket and the fitting body in which the pipe is to be disposed; and
forming a vent passage in the fitting body that opens through an axial end face of the fitting body to the space between the jacket and the fitting body and through a radial outer surface of the fitting body to facilitate venting fluid from the space between the jacket and the fitting body out of the pipe fitting assembly.

9. The method of claim 8, wherein forming the fitting body comprises:
forming an inner body to define the bore that extends through the pipe fitting assembly;
forming an outer body ring with a connector notch on the radial outer surface of the fitting body, wherein:
securing the axial end of the jacket to the fitting body comprises securing the axial end of the jacket to the outer body ring; and
forming the vent passage in the fitting body comprises forming the vent passage in the outer body ring; and
securing the outer body ring circumferentially around the inner body.

10. The method of claim 9, wherein forming the inner body comprises forming the inner body with serrations.

11. The method of claim 9, wherein securing the outer body ring circumferentially around the inner body comprises securing the outer body ring circumferentially around the inner body such that the inner body does not extend radially beyond the outer body ring.

12. The method of claim 8, wherein forming the vent passage in the fitting body comprises:
forming a first portion of the vent passage through the axial end face of the fitting body parallel to the bore of the pipe fitting assembly; and
forming a second portion of the vent passage through the radial outer surface of the fitting body to the first portion of the vent passage.

13. The method of claim 12, wherein forming the second portion of the vent passage comprises forming the second portion of the vent passage perpendicular to the first portion of the vent passage.

14. The method of claim 12, wherein forming the first portion of the vent passage comprises forming the first portion of the vent passage such that the first portion of the vent passage does not extend completely through the fitting body.

15. The method of claim 8, wherein securing the axial end of the jacket to the fitting body comprises welding the axial end of the jacket to the fitting body.

16. A method of using a pipe fitting assembly, comprising:
disposing a pipe within a space extending between a fitting body of the pipe fitting assembly and a jacket that is secured to the fitting body such that the jacket extends circumferentially and axially around a portion of the fitting body, wherein the fitting body defines a bore that extends through the pipe fitting assembly;
swaging the jacket around the pipe such that the jacket is conformally deformed around the pipe to facilitate securing and sealing tubing of the pipe within the pipe fitting assembly; and
venting fluid from the space between the jacket and the fitting body out of the pipe fitting assembly using a vent passage in the fitting body that opens through an axial end face of the fitting body to the space between the jacket and the fitting body and through a radial outer surface of the fitting body.

17. The method of claim 16, wherein the fitting body comprises:
an inner body that defines the bore that extends through the pipe fitting assembly; and
an outer body ring secured circumferentially around the inner body, wherein:
an axial end of the jacket is secured to the outer body ring; and
the outer body ring comprises:
the vent passage; and
a connector notch on the radial outer surface of the fitting body.

18. The method of claim 17, wherein swaging the jacket around the pipe comprises securing swaging equipment to the pipe fitting assembly via the connector notch on the outer body ring.

19. The method of claim 16, wherein venting the fluid from the space between the jacket and the fitting body out of the pipe fitting assembly comprises:
venting the fluid through a first portion of the vent passage that opens through the axial end face of the fitting body to the space between the jacket and the fitting body and that extends parallel to the bore of the pipe fitting assembly; and
venting the fluid through a second portion of the vent passage that connects to the first portion of the vent passage and that opens through the radial outer surface of the fitting body.

20. The method of claim 16, comprising connecting the fitting body to a fluid destination.
